(19) United States
(12) Patent Application Publication
(10) Pub. No.: US 2003/0074235 A1
(43) Pub. Date: Apr. 17, 2003

(54) User configured computer program

(76) Inventor: William Gregory, Exton, PA (US)

Correspondence Address: CLIFFORD A. POFF, 9800B MCKNIGHT ROAD, SUITE 115, PITTSBURGH, PA, 15237, US

(21) Appl. No.: 10/225,712

(22) Filed: Aug. 21, 2002

Related U.S. Application Data
(63) Continuation-in-part of application No. 09/613,552, filed on Jul. 10, 2000.

(51) Int. Cl. G06F 17/60; G06F 7/00; G06F 17/00

(52) U.S. Cl. 705/4; 707/104.1

(57) ABSTRACT

A computer program is scalable to change the operation of the software application without reprogramming. The program provides a screen painter for a user to create and customize forms to input data to a storage base. A configuration manager is used to select and input the operating parameters supplied to the storage base for the creation by a user command of one software application which is changeable in the same way it was created with out reprogramming.

### CROSS-REFERENCE TO RELATED APPLICATION

This application is a continuation in part of patent application Ser. No. 9/613,552 filed Jul. 10, 2000

### BACKGROUND OF THE INVENTION

1. Field of the Invention

This invention relates to a computer program designed to allow a user to configure the software for a user specified application and additional user specified applications without intervention or need for a programmer to alter the computer program and, more particularly, to such a computer program responsive to a user defined and built database including elements of the database and unique operating rules all used to generate an individual database and executable code.

2. The Prior Art

An administration system for an existing user of software must address an ever increasing need, costs and delays to modify the software to take advantage of any one or more of sources of information available on the Internet; modern data base systems and XML interfaces. One alternative to the use of a programmer to update an existing administration system or a new user is the purchase of state of the art software and incur additional costs to perform necessary software modifications but the final version may not be able to take advantage of new releases of the base system.

While the present invention is not so limited, it is particularly useful in the insurance industry because of the need for a solution to the need for continuing changes and requirements in the insurance industry. Object-oriented programming; add-in modules and the ability to access data from Web services offer only short-term solutions. Powerful broad based programs are only generic approaches and fail to provide the ability for industry specific formatting to collect data and compilations of only necessary data for a specific application in the industry. The use of such broad based programs is wasteful of resources and capacities of the associated computer hardware and gives rise to an opportunity for software conflicts. A need exists for computer programming using a configuration operator that would allow insurance business analysts, not computer programmers, to design the specifications and applied as user specified computer programming of the insurance industry. The configuration operator becomes a toolkit to create the actual software needed to run the custom system applications without the attribute of a software development environment and especially without the need to write programming code.

It is an object of the present invention to provide a completely scalable computer program to meet the changing nature of the users needs without intervention by a programmer.

It is another object of the present invention to provide a computer program operable by the provision of means to allow a user to custom design forms and associate each form field to one database specific to the application using the custom design forms and form fields.

It is a further object of the present invention to provide a computer program including means to add newly defined databases or a newly defined algorithm using dynamic builder templates to configure programming code without intervention by a programmer.

It is a more specific object of the present invention to provide a computer program for an insurance carrier having means to design forms or to add a new policy type or new policy coverage or a new state or a new rating bureau or define parameters of a rating engine without intervention by a programmer.

It is a further specific object of the present invention to provide a computer program for an insurance carrier having means to design parameters for gathering data and data to administer an insurance policy without intervention by a programmer and dynamic builder templates to configure programming code without intervention by a programmer.

### SUMMARY OF THE INVENTION

In accordance with the present invention there is provided a user configured computer program including the combination of first means responsive to user inputs for creating a plurality of data fields, program processing rules and a static database containing multiple storage tables, second means responsive to user inputs for creating user defined data input fields and storing each of the user defined data input fields in the multiple storage tables, third means responsive to user inputs for creating an operating program controlled by the program processing rules in response to user inputs to create ancillary data parameters and create an algorithm to process parameters of data, the multiple storage tables storing each of the ancillary data parameters and the algorithm, forth means responsive to user inputs for operating builder templates to create a computer software application using the select existing data tables, the user defined data tables, the user defined data input fields, the ancillary data parameters and the algorithm recovered from the static database to process all data entries and dynamically create a transactional storage data base for storage of all the transactional data in response to process entries by the computer software application.

In accordance with another aspect of the present invention there is provided a user configured computer program including the combination of a configuration manager including a plurality of existing data fields, program processing rules and a static database containing multiple storage tables, the configuration manager being responsive to user inputs to select existing data tables and to alter one or more of the existing data tables creating user defined data tables, the multiple storage tables storing each of said select existing data tables and the user defined data tables, a screen painter responsive to user inputs to create user defined data input fields, the multiple storage tables storing each of the user defined data input fields, an operating program controlled by said program processing rules in response to user inputs to create ancillary data parameters and create an algorithm to process parameters of data, the multiple storage tables storing each of the ancillary data parameters and the algorithm, dynamic builder templates activated by the user to create a computer software application using the select existing data tables, the user defined data tables, the user defined data input fields, the ancillary data parameters and the algorithm recovered from the static database to process all data entries and dynamically create a transactional storage data base for storage of all the transactional data in response to process entries by the computer software application, and a display module for selecting data from the transactional storage data base for display.

According to a more specific application of the present invention there is provided a completely scalable computer software application including memory for forming a static database, a screen painter responsive to user inputs to design forms and input data required by the insurance carrier's business to forms to allow user defined input data for use in the insurance carrier's business, the screen painter associating each user input data with a specific table in said memory, a configuration manager responsive to user inputs to select data fields, select business rules, customize data fields and customize business rules as desired by the user to conduct the insurance carriers business including associating data and business rules as input by the user with a specific table in said memory, a rating engine responsive to user inputs to create rating tables and rating algorithms required to support the use's business as determined by inputs from the user to the screen painter and the configuration manager, the rating engine associating all required rating tables and rating algorithms with a specific table in said memory and selected business rules of the configuration manager, dynamic builder templates activated by the user to utilize the user defined data in the static database of the memory for forming inputs to create a computer software application for receiving inputs by the user to the screen painter, the configuration manager and the rating engine to process all transactions for conducting the user's business, the dynamic builder templates operating to dynamically create a transactional database for storage of all transactional data required to conduct user's business, and reporting module responsive to user inputs for selecting data required for user's business from the transactional database for delivery from the reporting module to user.

### BRIEF DESCRIPTION OF THE DRAWING

These features and advantages of the present invention as well as others will be more fully understood when the following description is read in light of the accompanying drawings in which:

FIG. 1 is a block diagram of computer hardware for use with the computer program of the present invention;

FIG. 2 is a flow diagram of the architecture of computer program incorporating the user configured features of the present invention;

FIG. 3 is an example of a monitor display screen responsive to programming to select preprogrammed data entry fields as a selectable option for utilizing the screen painter program feature of the computer program of the present invention;

FIG. 4 is an example of monitor display screen to utilize the screen painter programming of the computer program of the present invention;

FIGS. 5 and 6 illustrate the basic architecture of the preferred embodiment of the computer program for an insurance carrier according to the present invention;

FIG. 7 is an example of monitor display screen to utilize the configuration manager program feature of the computer program for the insurance industry according to the present invention; and

FIG. 8 is an example of monitor display screen showing the final product of the user configured computer program for a user defined application in the insurance industry of the present invention.

### DETAILED DESCRIPTION OF THE INVENTION

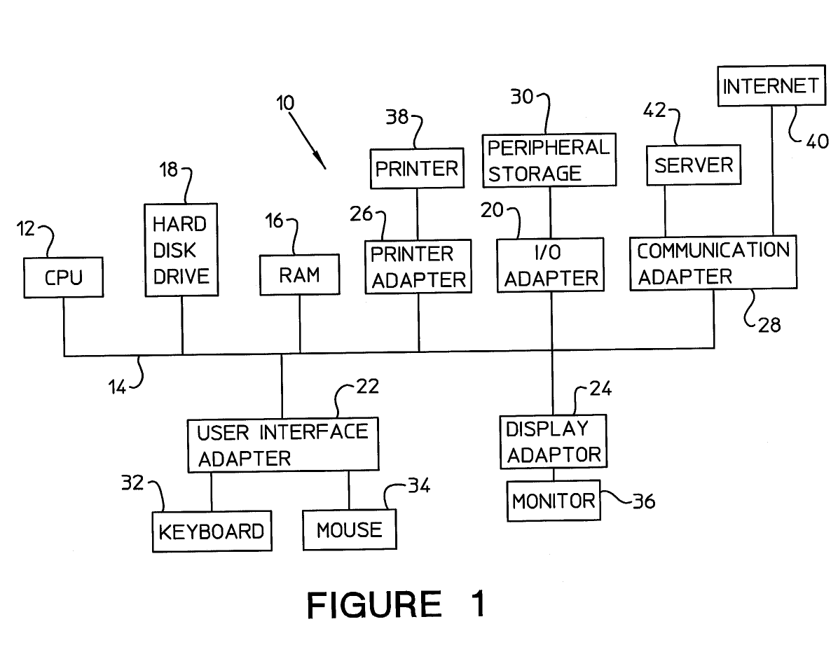

In FIG. 1 illustrates a typical computer hardware 10 forming a workstation for a user to execute the computer program embodying the present invention by which a user can reconfigure the computer program without reprogramming to modify and expand the software for applications as desired by a user. The computer hardware 10 essentially includes a central microprocessor processing unit (CPU) 12 which includes the usual ROM interconnected by a system bus 14 with a Random Access Memory (RAM) 16, Hard Disk Drive 18, an Input/Output adapter (I/O Adapter) 20, user interface adapter(s) 22, display adapter 24, a printer adaptor 26 and communication adapters 28. The Input/Output adapter 20 is used to connect a compact disk drive or other forms of data storage device 30 to the system bus 14. The user interface adapter 22 connects a keyboard 32and a mouse 34, to the system bus 14. The display adapter 24 connects a monitor 36 to the system bus 14. The printer adapter 26 connects a printer 38 to the system bus 14. The communication adapters 28 connect the workstation to an Internet service provider 40, and when the computer hardware is so configured connects the workstation to a network sever 42. The workstation has a resident operating system loaded on the hard disk drive 18 such as the Microsoft Windows 2000 operating system running on Intel architecture and can be ported to other hardware architecture such as an IBM AS400 server 42. However, various versions of Unix and Linux running on RISC architectures can be used. The databases are based on DB2 UDB database although MS SQLServer and Oracle databases can be used. Other software components within the computer program use Visual Basic 6.0, Java 1.4, JDK 1.4, WebSphere, EJB, HTML AND XML.

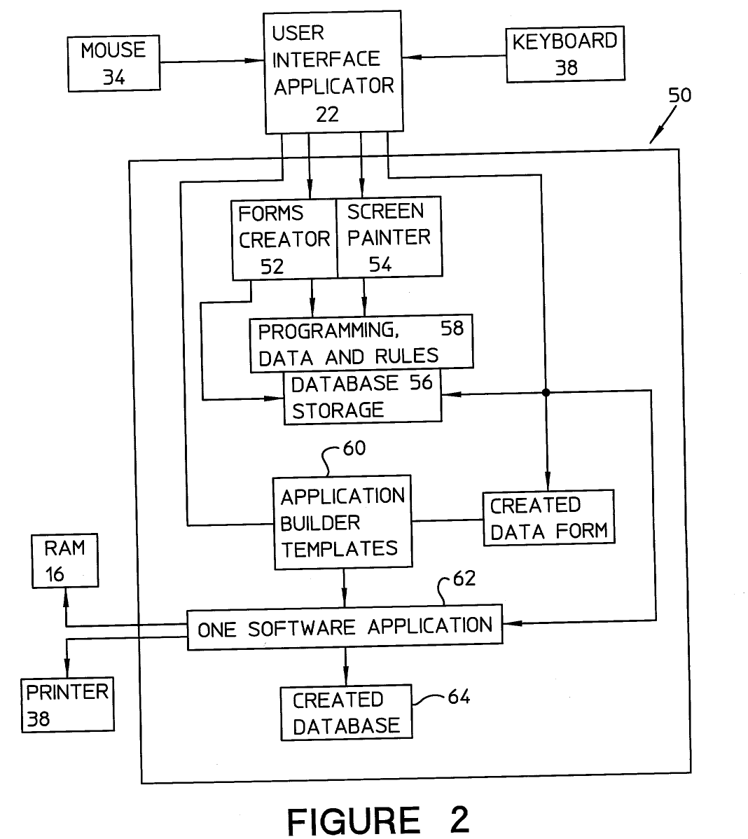

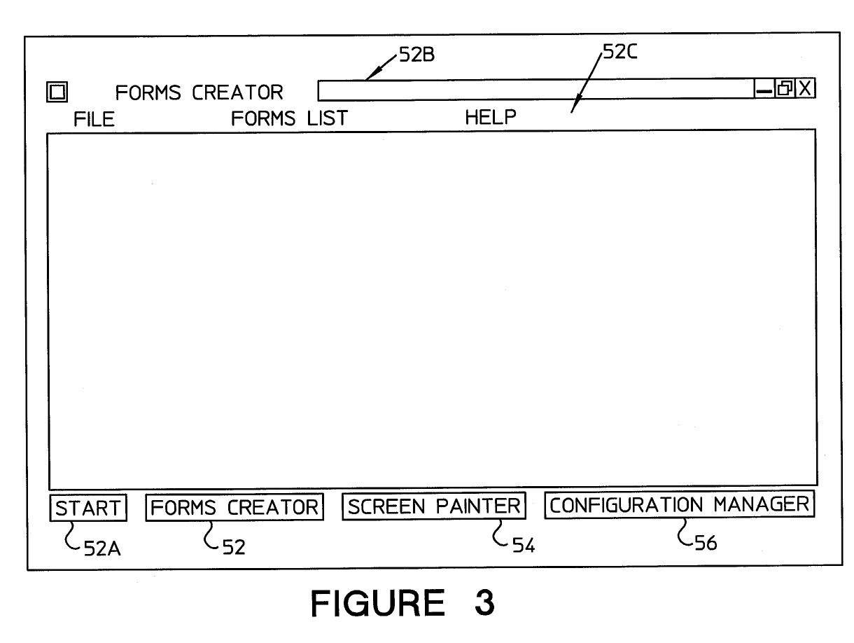

FIG. 2 illustrates the architecture of the computer program 50 incorporating the configured features by a user according to the present invention as operating on the computer hardware 10. Examples of industrial uses for the software provided by the computer program 50 are for bills of material, operations of a pharmaceutical company or a health insurance company. The computer program 50 includes a forms creator programming 52 read from the Hard Disk Drive 18 to RAM 16 in response to commands by a user of the keyboard 32 and/or mouse 34 forming user inputs to the interface adaptor 22. As typically illustrated in FIG. 3 when using a Windows operating system, the user inputs to select the forms creator-programming 52 produces a display on the monitor 36 that including a task bar 52A across the bottom of the screen, a title bar 52B across the top of the screen, and a toolbar 52C usually below the title bar. The task bar 52A allows the usual switching between programs especially, for example, between the forms creator program 52; a screen painter program 54 and a configuration manager program 56. The title bar 52B across the top of the screen displays min, max and close screen buttons and the name of the program down loaded from the hard disk drive and currently accessible for reading and writing in RAM. The toolbar 52C contains buttons used to activate functions of the currently running program, which notably allows selection of standard forms each with preprogrammed screens containing user entry fields for data. The selected standard forms, if any, are read from RAM to a static database on the hard disk drive using the forms creator programming 52.

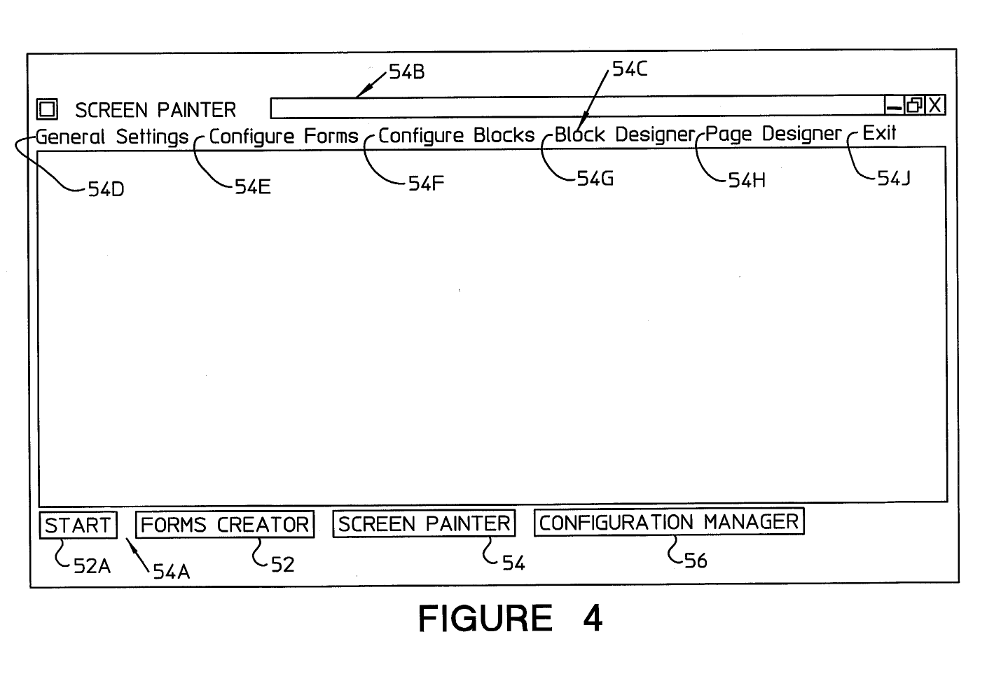

An important feature of the present invention resides in the provision of the screen painter program 54, the programming thereof allowing a user to create user defined screens containing user defined data input fields. FIG. 4 illustrates, when using a Windows operating system, a display on the monitor 36 that including a task bar 54A across the bottom of the screen, a title bar 54B across the top of the screen, and a toolbar 54C usually below the title bar. The task bar 54A and the title bar 54B provide the same type of functions as the bars 52A and 52B of FIG. 3. The operation of the screen painter program utilizes tool bars including options in pull down menu windows for selecting and optionally creating a plurality of data fields. In the illustrated example, the toolbar 54C contains buttons used to activate tasks which notably comprise: button 54D labeled General Settings provides the selection of formatting options for the data entry fields; button 54E labeled Configure Forms provides the option for configuring the data entry fields; button 54F labeled Configure Blocks provides the option for configuring the data blocks for the data entry fields; button 54G labeled Block Designer provides the option for designing data blocks for the data entry fields; button 54H labeled Page Designer provides the option for designing data pages; and button 54J labeled Exit is used to exit the screen painter program. The user defined forms with screens containing user defined data input fields are stored from RAM as a static database on the hard disk drive 18 as user defined data input fields in multiple storage tables of a storage database 56 defined by programming of a configuration manager 58.

The programming of the configuration manager 58 accepts user inputs of data from the formats of the selected standard forms and user defined forms created with the use of the screen painter programming and stored in the storage database 56. Other operations of the configuration manager 58 include using user inputs to the user interface adaptor to create program processing rules, create identification databases, create multiple storage tables and create algorithms to process numerical parameters of data.

All the data and files generated by operations of the configuration manager 58 are stored. Application builder templates 60 comprising programming activated by the user inputs for creating one computer software application 62 using the select existing data tables, the user defined data tables, the user defined data input fields, the ancillary data parameters and the algorithm recovered from the storage database to process all data entries and dynamically create a transactional storage data base 64 for storage of all the transactional data in response to processing entries by the computer software application.

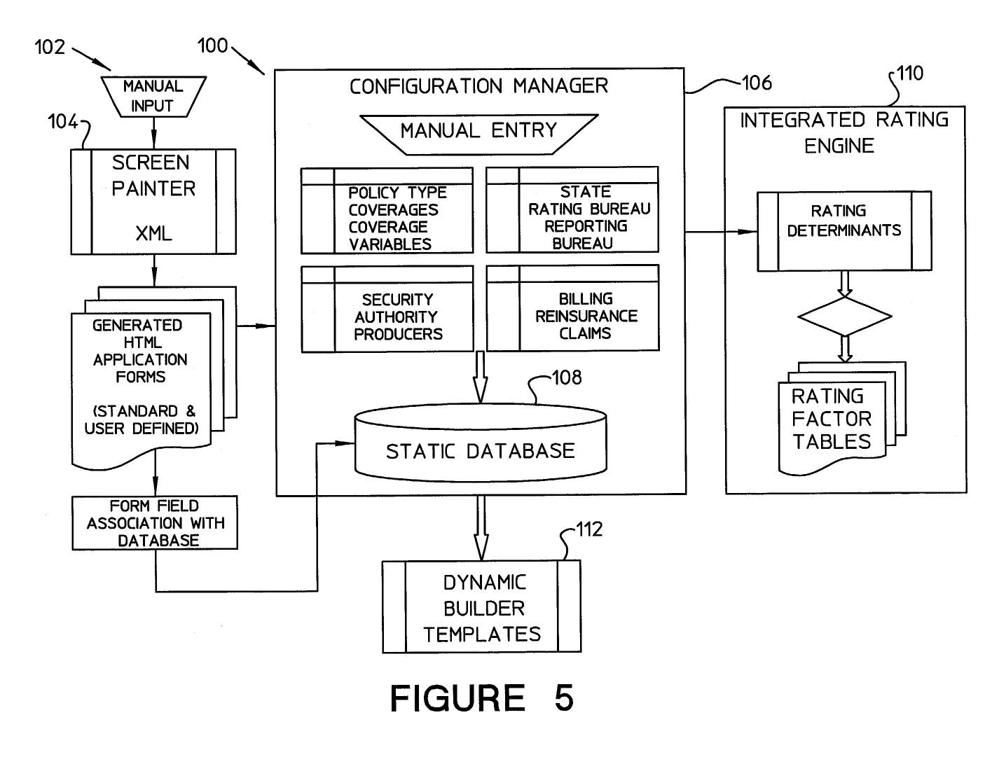

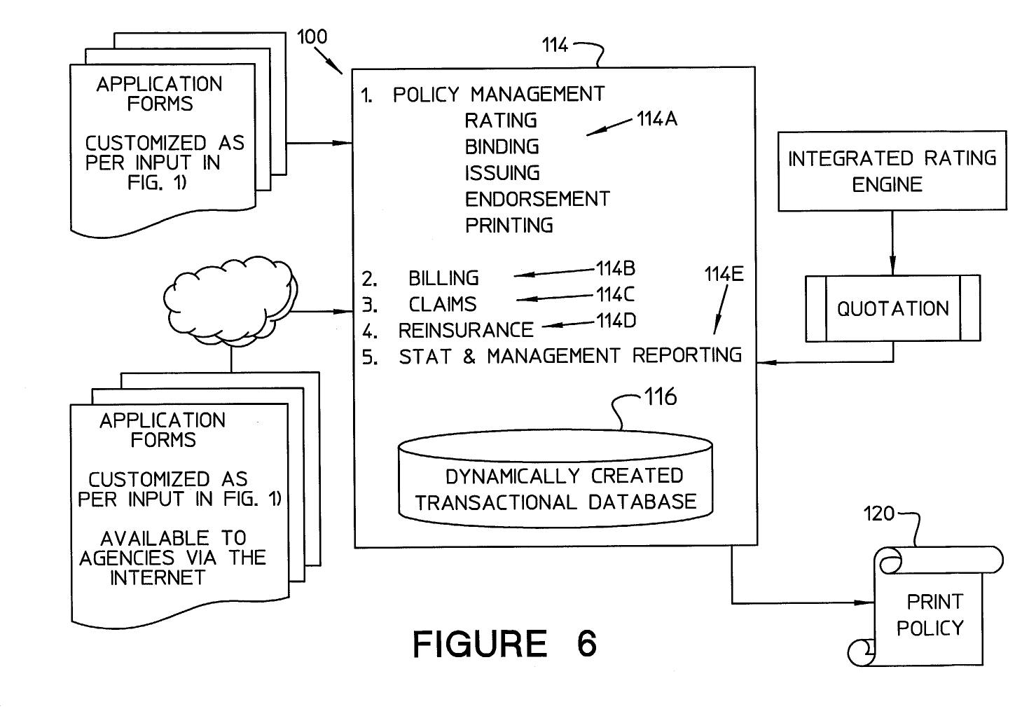

FIGS. 5 and 6 illustrate the basic architecture of the preferred embodiment of the computer program for an insurance carrier according to the present invention. The computer program 100 includes major components integrated to produce a computer software application. The major components include a forms generator programming 102 including a screen painter programming 104 for providing user selected standard application forms and user created application forms to collect data for an insurance application. A configuration manager programming 106 includes a static database 108 supplies data to an integrated rating engine 110. Programming comprising dynamic builder templates 112 produce a scalable computer software application 114 including a transactional data base 116, and a printing module 120. The software 100 is designed for windows 2000 operating system running on Intel architecture and can be ported to other hardware architecture such as AS400 server 42, various versions of Unix and Linux running on RISC architectures. Databases are based on DB2 UDB database although MS SQLServer and Oracle databases can be used. Other software components within the computer program use Visual Basic 6.0, Java 1.4, JDK 1.4, WebSphere, EJB, HTML AND XML.

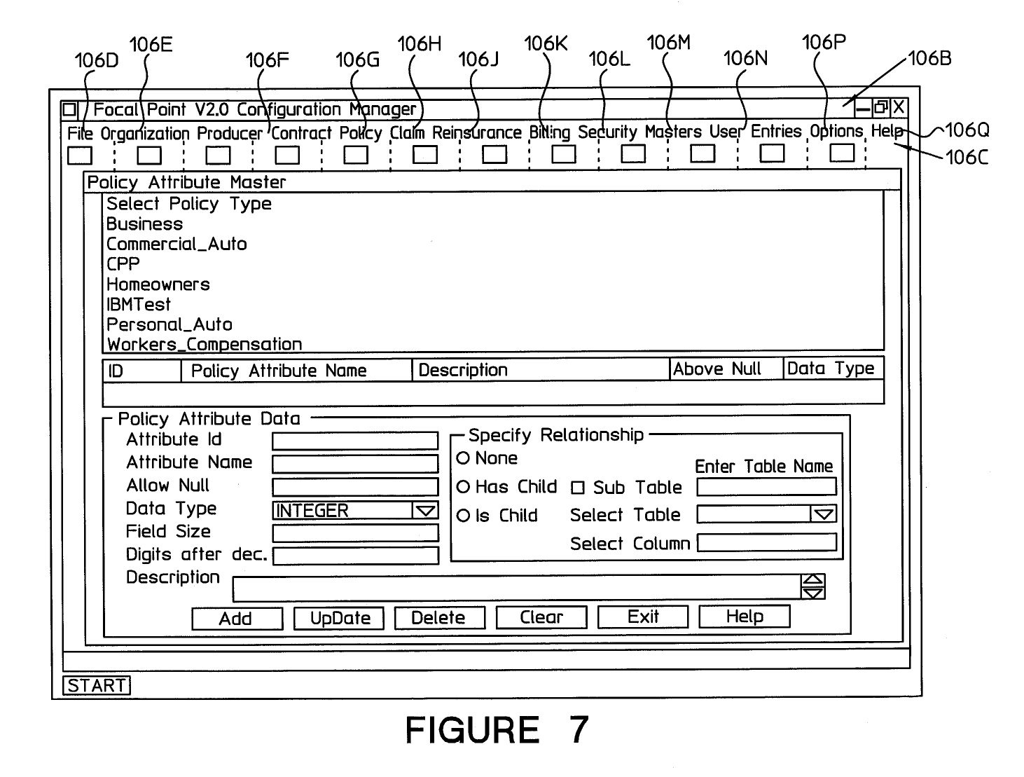

A user for an insurance company initially customizes the software to conform to the scope and contents of desired insurance policies within the scope of the business of the insurance company. The user executes the usual command as the first step to customize the software to load the computer program 100 to Ram from the hard disk drive and then, typically, the user accesses the configuration manager programming 106 to customize the software module to meet exact requirements of a specific insurance carrier. FIG. 7 illustrates a typical display of the home page of the configuration manager programming as found on the screen on the monitor 36. The user then proceeds to customize items required or desired to process, rate, bind, endorse and issue an insurance policy. The configuration manager also allows complete customization of claims, rules, billing rules including invoice forms and notices, reinsurance, accounting and reporting, all security rules within the insurance carrier and the identity of an individual user all by data entry using the keyboard 32 and mouse 34 of the hardware shown in FIG. 1. As shown in FIG. 7, a tool bar 106C located below a title bar 106B at the top of the monitor screen is used to access buttons that include the usual “File” button 106D; a button 106E labeled “Organization” provides a pull down window to allow a user to define the identity of the insurance company. The next button 106F labeled “Producer Contract” provides the user with option to introduce the identities of insurance agents and there contracts with the insurance company. Button 106G labeled “Policy” provides the option to identify the policy types underwriting rules coverages reading algorithm. Button 106H labeled “Claim” provides the option to identify claim processing rules. Button 106J labeled “Reinsurance” provides the option to identify all reinsurance contracts utilized by the insurance company. Button 106K labeled “Billing” provides the option to identify the billing terms and conditions and related procedures utilized by the insurance company. Button 106L labeled “Security” provides the option to set up the parameters for scope and identity of allowable users of the insurance program. Button 106M labeled “Masters” allows the introduction of transactional data to build the transactional database utilized by the insurance company. Button 106N labeled “User Entries” is a subset of the “Masters” option and provides the option to identify user-defined table/files within the transactional database used by the “Masters.” Button 106P labeled “Options” provides a toolbox environment for processing programming and data within the entire computer program. Button 106Q labeled “Help” provides the usual help options for user-friendly use of the computer program.

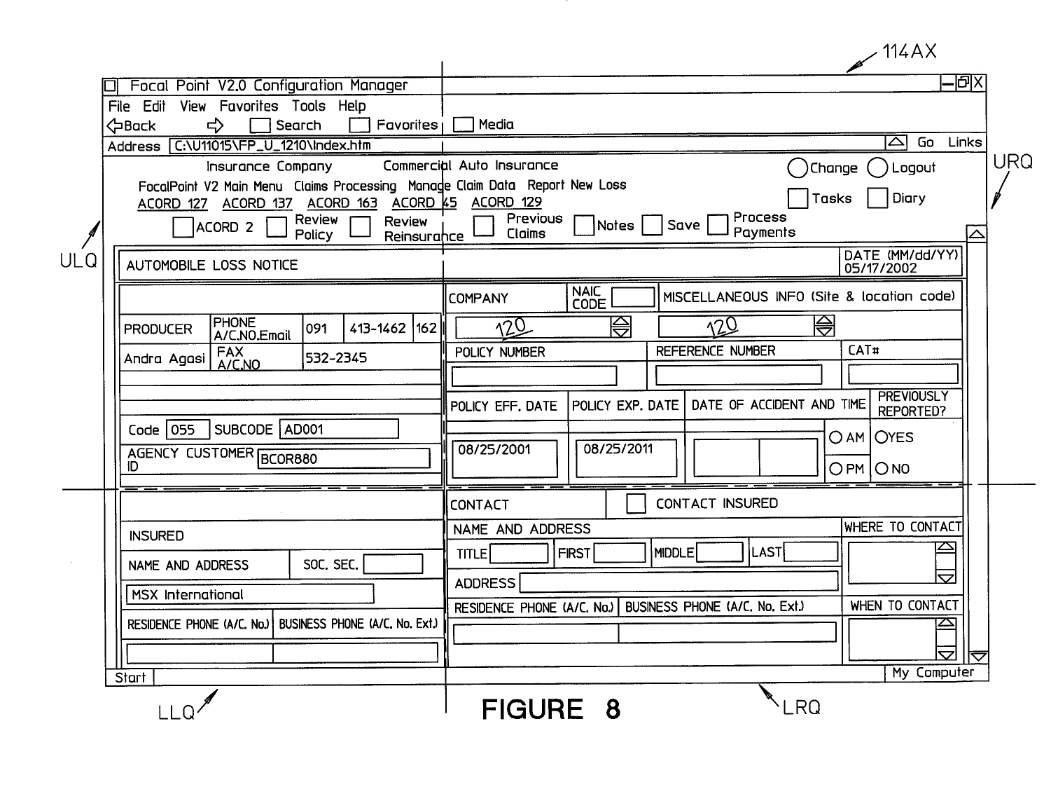

The next step for customizing the computer program is the creation by the user of form fields used to capture the specific data necessary for the creation and administration of an insurance policy. The user accesses through a main menu of the program the forms generator 102 where if desired, the user can select from pull down menus of a tool bar default insurance forms supplied as a part of the computer program to create the data capturing application forms that are required by the user specifically for the user's policy types, States in which the user intends to operate, Rating Bureaus to be used, coverage's to be offered, as described herein before and typically illustrated in FIG. 3. However, in according features of the present invention resides in the use of the screen painter 104 to allow the user to create customized application forms to capture the data necessary to process an insurance application. More particularly, the user creates the insurance application forms that are used by the insurance company to capture data required specifically for the user's business, which by way of examples are one or more different policy types, states in which the user intends to operate, rating bureaus to be used, insurance coverage to be offered. An example of the final product as displayed by the screen of monitor 36 of use of the screen painter programming is shown in FIG. 8. The forms are created using the screen painter and during the process of creation of the form, each form field is associated with a specific table in the static database 108 contained in the configuration manager 106. A non-technical user familiar with the configuration manager module can accomplish this process of creating the forms without the envelopment of programming.

The integrated rating engine programming 110 is a module to process the determinants including the use of appropriate rating tables used to rate an insurance policy based on the data captured by the forms created by the forms generator 102 and including the customized forms created by the use of the screen painter 104. The rating engine programming 110 also deploys the relevant rating algorithm and calculates the rate of premium for the insurance policy. The dynamic builder template 112 are software programmed modules executed by the user to create the scalable computer software application 114 which is accessed by the user to provide the normal operations within the business activities of the insurance carrier. Within the scalable computer software application 114 is a policy management 114A providing major sub-modules of: Data Capture, Rating using an integrated rating engine, Binding, Issuing, and Endorsements and Printing. An example of the final product as seen on a display by the screen of monitor 36 is shown in FIG. 8. The upper left quadrant “ULQ” containing identification of the insurance agent as imputed using user defined data entry windows customized by the use of the screen painter programming. The lower left quadrant “LLQ” contains identity information about the insured of which the scope and content are established and user configured, if desired, using the screen painter programming. The upper right quadrant “URQ” contains identification information about the insurance policy. This includes aspects of the insurance policy introduced by user entries using the configuration manager. The data for selection about the particular insurance policy is included in pull down windows 120 and may include rating tables and risk data acquired from data bases using the internet 40 supplied through the communications adapter 28. The URQ also includes data entry fields 122, which may be configured by the use of the screen painter programming for the introduction of insured lost claim data. The lower right quadrant “LRQ” contains contact information about the insured. The scalable computer software application 114 also includes a billing module programming 114B to provide all standard and customized billing cycles, a claims module programming 114C to provide all claims related tasks, a reinsurance module programming 114D to provide both reinsurance proceedings and reinsurance accounting and a static and reporting module programming 114E to provide accounting for all statutory and management reporting requirements.

While the present invention has been described in connection with the preferred embodiments of the various figures, it is to be understood that other similar embodiments may be used or modifications and additions may be made to the described embodiments for performing the same function of the present invention without deviating there from. Therefore, the present invention should not be limited to any single embodiment, but rather construed in breadth and scope in accordance with the recitation of the appended claims.

I claim:

1. A user configured computer program including the combination of:
a configuration manager programming having a static database storage and including programming pre-programmed data fields and processing rules, said configuration manager programming being responsive to user inputs to select existing data tables and to alter one or more of said pre-programmed data tables for creating user defined data tables, said static database storage storing each of said select preprogrammed data tables and said user defined data tables;
a screen painter responsive to user inputs to create user defined data input fields, said multiple storage tables storing each of said user defined data input fields;
an operating program controlled by said program processing rules in response to user inputs to create ancillary data parameters and create an algorithm to process parameters of data, said multiple storage tables storing each of said ancillary data parameters and said algorithm; and
dynamic builder templates activated by the user to create a computer software application using said select existing data tables, said user defined data tables, said user defined data input fields, said ancillary data parameters and said algorithm recovered from said static database to process all data entries and dynamically create a transactional storage data base for storage of all the transactional data in response to process entries by said computer software application.

2. The user configured computer program according to claim 1 further including a display module for selecting data from said transactional storage data base for display.

3. The user configured computer program according to claim 1 wherein said static database storage contains multiple storage tables.

4. The user configured computer program according to claim 1 wherein said preprogrammed data fields further including a plurality of existing data fields.

5. The user configured computer program according to claim 1 wherein said configuration manager programming provides user defined entries for the insurance industry including policy type, policy coverages, policy coverage and policy variables.

6. The user configured computer program according to claim 1 wherein said configuration manager programming provides user defined entries for the insurance industry including the political state of the insurance writer, rating bureau and reporting bureau.

7. The user configured computer program according to claim 1 wherein said configuration manager programming provides user defined entries for the insurance industry including security authority and producers of an insurance company.

8. The user configured computer program according to claim 1 wherein said configuration manager programming provides user defined entries for the insurance industry including billing, reinsurance and claims handling under operation by an insurance company.

9. The user configured computer program according to claim 1 wherein said operating program provides defined entries for the insurance industry including a rating engine program for responding to rating determinates using rating factor tables for issuing insurance policies and administering insurance policies.

10. The user configured computer program according to claim 1 wherein said computer software application formed by said dynamic builder templates programming provides insurance policy management functions including rating, binding issuing endorsing and printing.

11. The user configured computer program according to claim 1 wherein said computer software application formed by said dynamic builder templates programming provides insurance policy management functions including billing.

12. The user configured computer program according to claim 1 wherein said computer software application formed by said dynamic builder templates programming provides insurance policy management functions including claims.

13. The user configured computer program according to claim 1 wherein said computer software application formed by said dynamic builder templates programming provides insurance policy management functions including reinsurance.

14. The user configured computer program according to claim 1 wherein said computer software application formed by said dynamic builder templates programming provides insurance policy management functions including statistics and management reporting.

15. A user configured computer program including the combination of:
first means responsive to user inputs for creating a plurality of data fields, program processing rules and a static database containing multiple storage tables;
second means responsive to user inputs for creating user defined data input fields and storing each of the user defined data input fields in the multiple storage tables;
third means responsive to user inputs for creating an operating program controlled by the program processing rules in response to user inputs to create ancillary data parameters and create an algorithm to process parameters of data, the multiple storage tables storing each of the ancillary data parameters and the algorithm;
fourth means responsive to user inputs for executing builder templates programming to create a computer software application using the select existing data tables, the user defined data tables, the user defined data input fields, the ancillary data parameters and the algorithm recovered from the static database to process all data entries and dynamically create a transactional storage data base for storage of all the transactional data in response to process entries by the computer software application.

16. A completely scalable computer software application including, memory for forming a static database,
a screen painter responsive to user inputs to design forms and input data required by the insurance carrier's business to forms to allow user defined input data for use in the insurance carrier's business, the screen painter associating each user input data with a specific table in said memory, a configuration manager responsive to user inputs to select data fields, select business rules, customize data fields and customize business rules as desired by the user to conduct the insurance carriers business including associating data and business rules as input by the user with a specific table in said memory,
a rating engine responsive to user inputs to create rating tables and rating algorithms required to support the user's business as determined by inputs from the user to the screen painter and the configuration manager, the rating engine associating all required rating tables and rating algorithms with a specific table in said memory and selected business rules of the configuration manager, and
dynamic builder templates activated by the user to utilize the user defined data in the static database of the memory for forming inputs to create a computer software application for receiving inputs by the user to the screen painter, the configuration manager and the rating engine to process all transactions for conducting the user's business, the dynamic builder templates operating to dynamically create a transactional database for storage of all transactional data required to conduct user's business.

17. The completely scalable computer software application according to claim 16 further including a reporting module responsive to user inputs for selecting data required for user's business from the transactional database for delivery from the reporting module to user.
